(19) United States
(12) Patent Application Publication
(10) Pub. No.: US 2009/0086357 A1
(43) Pub. Date: Apr. 2, 2009

(54) IN DRIVE WRITTEN SPIRALS FOR SELF SERVO WRITING

(75) Inventor: Richard M. Ehrlich, Saratoga, CA (US)

Correspondence Address: SCHWEGMAN, LUNDBERG & WOESSNER/TOSHIBA, P.O. BOX 2938, MINNEAPOLIS, MN, 55402, US

(73) Assignees: Toshiba America Information Systems, Inc.; Kabushiki Kaisha Toshiba 1-1, tokyo (JP)

(21) Appl. No.: 11/864,459

(22) Filed: Sep. 28, 2007

(51) Int. Cl. G11B 5/02

(52) U.S. Cl. 360/55

(57) ABSTRACT

A method of self servo writing is shown. In example embodiments, spirals or other indexing patterns can be written entirely within a hard disk drive, thus enabling self servo writing of the entire disk surface. Increased accuracy in spiral writing in turn increases the track density achievable using self servo writing techniques. One example method includes writing a first indexing pattern, then using the first indexing pattern to servo and write an adjacent second indexing pattern. Other example methods further include the use of back electromotive force (EMF) to increase accuracy in writing patterns such as spirals.

### BACKGROUND

A disk drive is an information storage device. A disk drive includes one or more disks clamped to a rotating spindle and at least one head for reading information representing data from and/or writing data to the surfaces of each disk. The head is supported by a suspension coupled to an actuator that may be driven by a voice coil motor. Control electronics in the disk drive provide electrical signals to the voice coil motor to move the head to desired positions on the disks to read and write the data in tracks on the disks and to park the head in a safe area when not in use or when otherwise desired for protection of the disk drive.

Servo zones are commonly written onto a disk surface to locate the read/write head on the disk surface during operation.

### BRIEF DESCRIPTION OF THE DRAWINGS

FIG. 1 is a perspective view of a magnetic recording and reproducing apparatus (hard disk drive) according to an example embodiment;

FIG. 2 is a schematic plan view of a magnetic disk according to an example embodiment;

FIG. 3 is a perspective view of a portion of a magnetic disk according to an example embodiment;

FIG. 4 is a schematic diagram showing a servo zone and a data zone in a magnetic disk according to an example embodiment;

FIG. 5 is a plan view showing patterns in a servo zone and a data zone in a magnetic disk according to an example embodiment;

FIG. 6 is a block diagram of the magnetic recording and reproducing apparatus (hard disk drive) according to an example embodiment;

FIG. 7 is a schematic plan view of a magnetic disk according to an example embodiment;

FIG. 8 is a schematic plan view of a magnetic disk during a manufacturing process according to an example embodiment;

FIG. 9 is another schematic plan view of a magnetic disk during a manufacturing process according to an example embodiment;

FIG. 10 is a flow diagram of a method according to an example embodiment; and

FIG. 11 is an example block diagram of a computer system for implementing methods and devices as described in accordance with example embodiments.

### DETAILED DESCRIPTION

Hereinafter, example embodiments of the present invention will be described with reference to the drawings.

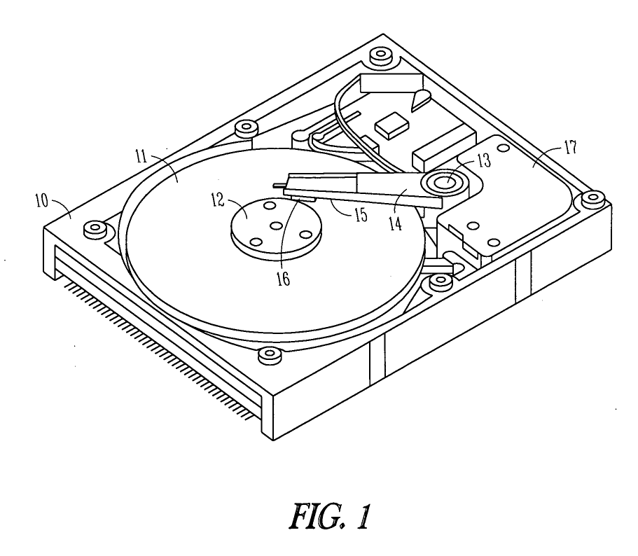

FIG. 1 is a perspective view of a magnetic recording and reproducing apparatus (hard disk drive) according to an example embodiment. The magnetic recording and reproducing apparatus comprises, inside a chassis 10, a magnetic disk 11, a head slider 16 including a read head and a write head, a head suspension assembly (a suspension 15 and an actuator arm 14) that supports the head slider 16, a voice coil motor (VCM) 17 and a circuit board.

The magnetic disk 11 is mounted on and rotated by a spindle motor 12. Various digital data are recorded on the magnetic disk 11. In an example embodiment, the magnetic head incorporated in the head slider 16 is an integrated head including a write head of a single pole structure and a read head using a shielded magneto resistive (MR) read element (such as a GMR film or a TMR film). The suspension 15 is held at one end of the actuator arm 14 to support the head slider 16 to face the recording surface of the magnetic disk 11. The actuator arm 14 is attached to a pivot 13. The voice coil motor (VCM) 17, which drives the actuator, is provided at the other end of the actuator 14. The VCM 17 drives the head suspension assembly to position the magnetic head at an arbitrary radial position of the magnetic disk 11. The circuit board comprises a head integrated circuit (IC) to generate driving signals for the VCM and control signals for controlling read and write operations performed by the magnetic head.

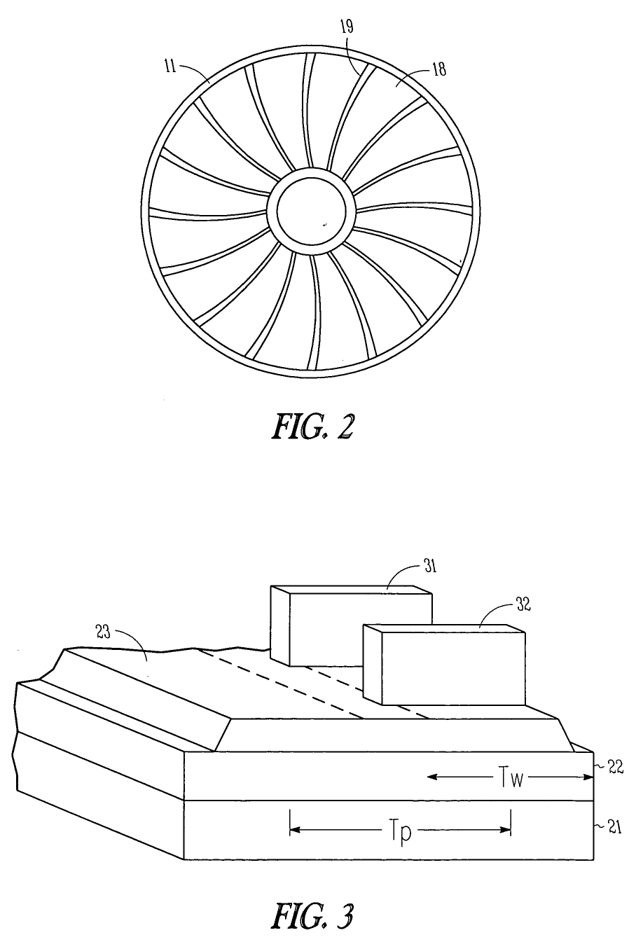

FIG. 2 is a schematic plan view of a magnetic disk 11 according to an example embodiment. FIG. 2 shows data zones 18 and servo zones 19. User data is recorded in each of the data zones 18. This example magnetic disk has tracks formed of concentric magnetic patterns. The recording tracks will be described later by way of example with reference to FIG. 3. Servo data for head positioning is formed in each of the servo zones 19 as patterns of a differently magnetized material. In one example embodiment as shown in FIG. 2, the servo zone 19 is shaped like a circular arc corresponding to a locus of a head slider during access. Methods of forming servo zones 19 and self servo writing will be discussed in more detail below.

FIG. 3 is a perspective view of one example of a data zone in a magnetic disk media according to an example embodiment. A soft underlayer 22 is formed on a substrate 21 with magnetic patterns constituting the recording tracks 23. The radial width and track pitch of the recording track 23 are denoted as Tw and Tp, respectively. A GMR element 31 of a read head and a single pole 32 of a write head, which are formed in the head slider, are positioned above the recording track 23.

As the substrate 21, a flat glass substrate may be used. The substrate 21 is not limited to the glass substrate but an aluminum substrate (or any other suitable substrate) may be used. A magnetic material is placed onto the substrate 21 and selectively magnetized to form recording tracks. A magnetic material such as CoCrPt may be used, although example embodiments are not so limited. Although not shown, a protective film of diamond-like carbon (DLC) may be formed on the surfaces of the media. In one example, lubricant may be applied to the surface of the protective film.

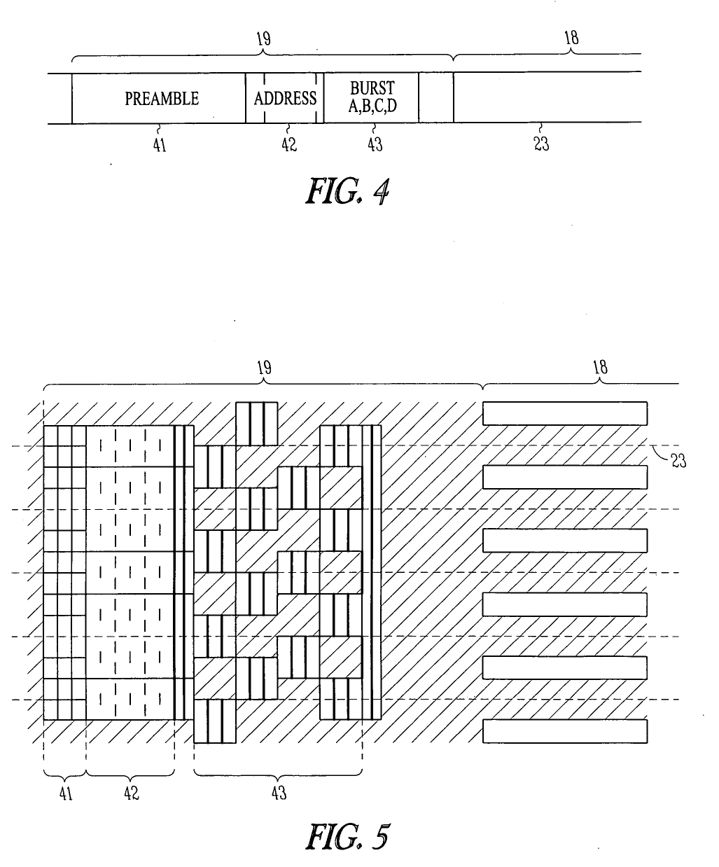

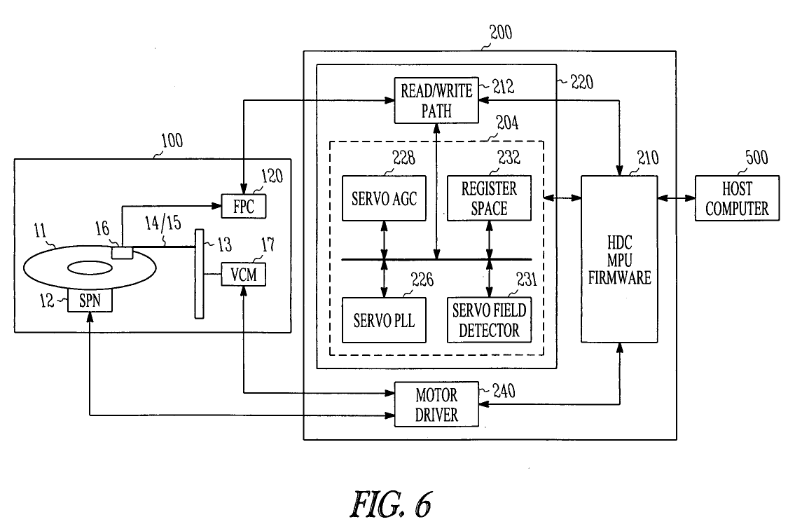

With reference to FIGS. 4 and 5, the patterns of the servo zone and data zone will be described. As schematically shown in FIG. 4, the servo zone 19 includes a preamble section 41, an address section 42, and a burst section 43 for detecting deviation.

As shown in FIG. 5, the data zone 18 includes the recording tracks 23. Patterns of the magnetization which provide servo signals are formed in each of the preamble section 41, address section 42, and burst section 43 in the servo zone 19. These sections may have the functions described below.

The preamble section 41 is provided to execute a phase lock loop (PLL) process for synthesizing a clock for a servo signal read relative to deviation caused by relative motions of the heads and media, and an AGC process for maintaining appropriate signal amplitude.

The address section 42 may have servo signal recognition codes called servo marks, sector data, cylinder data, and the like formed at the same pitch as that of the preamble section 41 in the circumferential direction using encoding, for example Manchester, or other types of encoding. The burst section 43 is an example of an off-track detecting region used to detect the amount of off-track with respect to the on-track state for a cylinder address. The burst section 43 includes patterns to locate a read or write head with respect to a desired track center. A pattern in FIG. 5 is shown by way of example including four fields of burst marks (A, B, C, and D), whose patterns in a radial direction are shifted relative to each other in respective fields. Other burst patterns could also be used. In one example, plural marks are arranged at the same pitch as that of the preamble section in the circumferential direction.

The principle of detection of a position on the basis of the burst section 43 will not be described in detail. When using the pattern shown, the off-track amount may be obtained by calculating the average amplitude value of read signals from the A, B, C, and D bursts. As discussed above, other patterns may be used that do not depend on average amplitude.

FIG. 6 shows a block diagram of the magnetic recording and reproducing apparatus (hard disk drive) according to an example embodiment. Although an example is shown, one of ordinary skill in the art, having the benefit of the present disclosure, will recognize that other device and circuit configurations are possible, and within the scope of the present invention. This Figure shows the head slider 16 only above the top surface of the magnetic disk 11. However, the magnetic recording layer is formed on each side of the magnetic disk. A down head and an up head may be provided above the bottom and top surfaces of the magnetic disk, respectively. The disk drive includes a main body unit called a head disk assembly (HDA) 100 and a printed circuit board (PCB) 200.

As shown in FIG. 6, the HDA 100 has the magnetic disk 11, the spindle motor 12, which rotates the magnetic disk 11, the head slider 16, including the read head and the write head, the suspension 15 and actuator arm 14, the VCM 17, and a head amplifier (HIC), which is not shown. The head slider 16 is provided with a read head including a read element, such as a giant magnetoresistive (GMR) element and a write head similar to elements 31 and 32 as shown in FIG. 3.

The head slider 16 may be elastically supported by a gimbal provided on the suspension 15. The suspension 15 is attached to the actuator arm 14, which is rotatably attached to the pivot 13. The VCM 17 generates a torque around the pivot 13 for the actuator arm 14 to move the head in the radial direction of the magnetic disk 11. The HIC is fixed to the actuator arm 14 to amplify input signals to and output signals from the head. The HIC is connected to the PCB 200 via a flexible cable 120. Providing the HIC on the actuator arm 14 may effectively reduce noise in the head signals. However, the HIC may be fixed to the HDA main body.

As described above, the magnetic recording layer is formed on each side of the magnetic disk 11, and the servo zones 19, each shaped like a circular arc, are formed so as to correspond to the locus of the moving head. The specifications of the magnetic disk meet outer and inner diameters and read/write characteristics adapted to a particular drive. The radius of the circular arc formed by the servo zone 19 is given as the distance from the pivot to the magnet head element.

In the illustrated example embodiment, several major electronic components, so-called system LSIs, are mounted on the PCB 200. The system LSIs are a controller 210, a read/write channel IC 220, and a motor driver IC 240. The controller 210 includes a disk controller (HDC) and an MPU, and firmware. The MPU is a control unit of a drive system and includes ROM, RAM, CPU, and a logic processing unit that implements a head positioning control system according to the present example embodiment. The logic processing unit is an arithmetic processing unit comprised of a hardware circuit to execute high-speed calculations. Firmware for the logic processing circuit is saved to the ROM or elsewhere in the disk drive. The MPU controls the drive in accordance with firmware.

The disk controller (HDC) is an interface unit in the hard disk drive which manages the whole drive by exchanging information with interfaces between the disk drive and a host computer 500 (for example, a personal computer) and with the MPU, read/write channel IC 220, and motor driver IC 240.

The read/write channel IC 220 is a head signal processing unit relating to read/write operations. The read/write channel IC 220 is shown as including a read/write path 212 and a servo demodulator 204. The read/write path 212, which can be used to read and write user data and servo data, may include front end circuitry useful for servo demodulation. The read/write path 212 may also be used for self-servowriting. It should be noted that the disk drive also includes other components, which are not shown because they are not necessary to explain the example embodiments.

The servo demodulator 204 is shown as including a servo phase locked loop (PLL) 226, a servo automatic gain control (AGC) 228, a servo field detector 231 and register space 232. The servo PLL 226, in general, is a control loop that is used to provide frequency and phase control for the one or more timing or clock circuits (not shown in FIG. 6) within the servo demodulator 204. For example, the servo PLL 226 can provide timing signals to the read/write path 212. The servo AGC 228, which includes (or drives) a variable gain amplifier, is used to keep the output of the read/write path 212 at a substantially constant level when servo zones 19 on one of the disks 11 are being read. The servo field detector 231 is used to detect and/or demodulate the various subfields of the servo zones 19, including a SAM (Servo Address Mark), a track number, a first servo burst, and a second servo burst. The MPU is used to perform various servo demodulation functions (e.g., decisions, comparisons, characterization and the like) and can be thought of as being part of the servo demodulator 204. In the alternative, the servo demodulator 204 can have its own microprocessor.

One or more registers (e.g., in register space 232) can be used to store appropriate servo AGC values (e.g., gain values, filter coefficients, filter accumulation paths, etc.) for when the read/write path 212 is reading servo data, and one or more registers can be used to store appropriate values (e.g., gain values, filter coefficients, filter accumulation paths, etc.) for when the read/write path 212 is reading user data. A control signal can be used to select the appropriate registers according to the current mode of the read/write path 212. The servo AGC value(s) that are stored can be dynamically updated. For example, the stored servo AGC value(s) for use when the read/write path 212 is reading servo data can be updated each time an additional servo zone 19 is read. In this manner, the servo AGC value(s) determined for a most recently read servo zone 19 can be the starting servo AGC value(s) when the next servo zone 19 is read.

The read/write path 212 includes the electronic circuits used in the process of writing and reading information to and from the magnetic disks 11. The MPU can perform servo control algorithms, and thus, may be referred to as a servo controller. Alternatively, a separate microprocessor or digital signal processor (not shown) can perform servo control functions.

Servo zones such as zones 19 illustrated in FIG. 2 are commonly used to control read/write head location over a disk 11 as discussed in examples above. Writing servo zones on a surface of a disk is an important operation that in many manufacturing processes is very time consuming. Self servo writing has been used to write servo zones within a hard disk drive, so that after assembly, the hard disk drive can effectively sit on a shelf and complete its own manufacture without additional human contact. Some reference pattern is commonly used to provide some frame of reference for the hard disk drive to use when performing self servo writing.

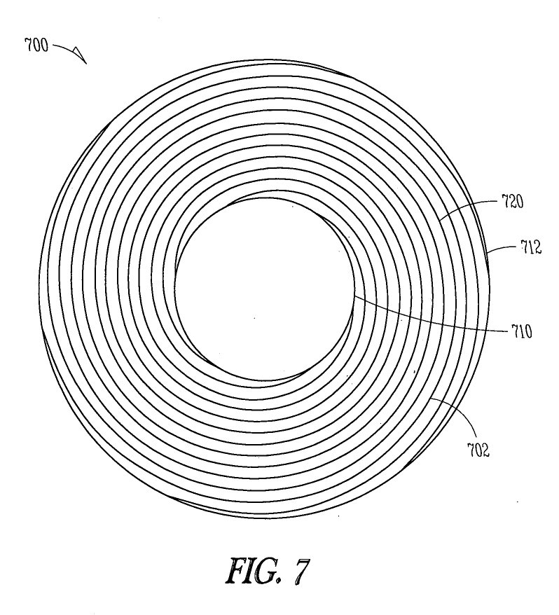

FIG. 7 shows a hard disk 700 with a number of spirals 720 as a reference pattern written between an inner diameter 710 and an outer diameter 712 of the hard disk surface 702. One method of self servo writing uses a pattern of spirals on a disk surface 702 to provide a rough frame of reference for a hard disk drive to use when writing a final servo pattern such as the examples shown in FIGS. 2 and 3 and discussed above. The intermediate step of writing spirals is relatively fast, and allows the hard disk drive to spend most of the time writing servo zones on a shelf using self servo writing methods. After writing the servo zones such as example zones 19 from FIGS. 2 and 3, the spirals 720 can be written over, and are no longer needed. Although the time spent by the hard disk drive performing self servo writing may still be long, the process does not affect other manufacturing processes, and it is performed without extensive processing machinery and without human labor.

For illustration, FIG. 7 shows six spirals 720, each with two revolution of the disk between the inner diameter 710 and the outer diameter 712. Amore useful spiral configuration is on the order of 300 or more spirals and approximately 15 revolutions between inner diameter 710 and outer diameter 712. Because density of tracks on a give disk surface is constantly increasing, improved methods of writing spirals are needed as new generations of hard disk drives are developed.

One method of writing spirals uses a media writer and is performed outside the hard disk drive as illustrated in FIG. 1. Media writers stack several disks on a common spindle, and write patterns to the disks using multiple corresponding write heads. Although a media writer is capable of writing several disks at a time, the disks must be first loaded onto the spindle, and unloaded after writing, then assembled into each hard disk drive. The process is time consuming with a number of steps requiring physical handling of the disks. Steps involving physical handling of disks increase possibility of scratching or otherwise damaging the disks. It is desirable to reduce any likelihood of damage to the disks.

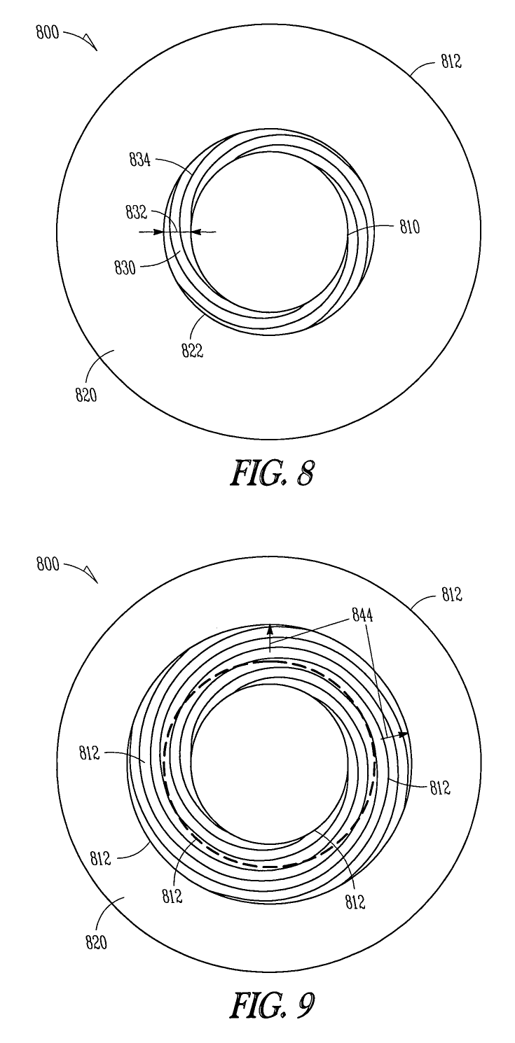

FIGS. 8 and 9 illustrate a method that uses spirals for self servo writing that is capable of being performed completely within a hard disk drive. FIG. 8 shows a hard disk 800 with an inner diameter 810 and an outer diameter 812. A first indexing pattern is written to form a first indexed region 830 having a width 832, and leaving a blank region 820 that is unindexed. In one example, the first indexing pattern includes a first number of spirals 834. In one example, the width 832 of the first region is approximately 10% of a radial distance between the inner diameter 810 and the outer diameter 812. Although spirals are shown, example embodiments are not so limited. Other indexing patterns, such as lines, curves, shapes, or other combinations, etc. are within the scope of the invention. One example of a number of spirals includes 300 or more individual spirals. Fewer spirals are shown in FIG. 8 for purposes of illustration. A first interface 822 is shown between the first region 830 and the blank region 820.

In one example, spirals provide a rough indexing pattern that a hard disk drive can use to self servo write a final servo pattern such as a number of servo zones at a later time, as discussed above. Although FIG. 8 shows the first indexed region 830 located adjacent to the inner diameter 810, example embodiments are not so limited. Other examples include the first indexed region being written adjacent to the outer diameter 812, or in the middle of the disk 800.

In one example, the first number of spirals 834 are written within the hard disk drive using back electromotive force (EMF) feedback from moving elements within the hard disk drive. For example, as components of the voice coil motor (VCM) are actuated, the motion of the VCM also generates a back EMF as the wires move through magnetic fields in the VCM. The back EMF of the VCM is detected and feedback is generated to provide a radial velocity of the read write head over the disk surface. That velocity can be integrated to provide an estimate of the radial position of the read write head over the disk surface. Further, in one example, back EMF from a spindle motor is detected and feedback is generated to provide a disk speed, which provides circumferential position information of the read/write head.

FIG. 9 shows a second indexing pattern that is written adjacent to the first indexed region 830 to form a second indexed region 840. In one example embodiment, the second indexing pattern includes a number of spirals. In FIG. 9, the spirals in the second indexed region 840 have been written from a location adjacent to the first interface 822 to a second interface 842, where the second interface 842 is now defined between the second indexed region 840 and the blank region 820. Arrows 844 shown a direction of writing of the spirals in the second indexed region 840. As discussed above, as shown, regions containing spirals are written from the inner diameter outward, however other example embodiments include writing from an outer diameter inward.

In one example embodiment, the second indexed region 840 is written using the first indexed region to servo the read/write head at or near the first interface 822. One example of using the first indexed region to servo the read/write head includes performing a self servo operation in the first indexed region to replace the spiral pattern with a final servo pattern. One example of using the first indexed region to servo the read/write head includes servoing the read/write head using the spirals themselves. In example embodiments where a final servo pattern is self servo written before writing spirals in the second indexed region, greater accuracy in servo location is obtained.

By writing spirals in only a first portion such as 10% of the radial distance between the inner diameter 810 and the outer diameter 812 using back EMF, then servoing from the first indexed region 830, greater accuracy is achieved in the second indexed region 840 than if only back EMF alone were used in the second indexed region 840. This is true because while servoing at the inner edge of the first written region, the drive can characterize and compensate for minor inaccuracies in the radial or circumferential positioning of the spiral patterns. Because only a small portion of the total stroke of the drive is written at one time, minor errors in the estimated spin-speed of the disk or the radial speed of the heads will result in only small errors in the radial and/or circumferential placement of the spirals.

In one example embodiment, the second indexed region 840 is written using both servo data from the first indexed region, and using back EMF from the VCM, back EMF from the spindle motor or back EMF from both the VCM and the spindle motor. The additional feedback from servo data in the first indexed region 830 and back EMF provides increased accuracy in placing spirals or other patterns in the second indexed region 840.

In one example embodiment, the second indexed region 840 abuts the interface 822. In one example embodiment, the second indexed region 840 radially overlaps the first indexed region 830 near the first interface 822. In one example embodiment, as in the first indexed region 830, the spirals in the second indexed region 840 are replaced by self servo writing a final servo pattern over the second indexed region 840. If a mismatch exists in a circumferential or radial alignment between the spirals in the first indexed region 830 and the spirals in the second indexed region 840, the mismatch may be measured and compensated for when self servo writing the final servo pattern in the second indexed region.

To measure and compensate for mismatch in one example embodiment, the drive servos the heads in a region that contains spirals from both the first and the second indexed regions. The drive servos using position information from the first set of spirals but also determines position and timing information from the second set of spirals. Using techniques that are well known to one of ordinary skill in the art, the drive combines the measured position information from the first set of spirals and a measured (or modeled) loop transfer-function for the servo controller to determine the radial mis-placement of the first set of spirals. Then, the drive uses that information, plus the measured position information from the second set of spirals to determine the radial mis-placement of that set of spirals, relative to the first set. The relative timing of the spirals is determined by comparing the time of encounter of each spiral to a clock that is generated from a phase-locked-loop that is locked to the spindle back-EMF signals. Although one mismatch compensation method is described, one of ordinary skill in the art, having the benefit of the present disclosure will recognize that other methods are within the scope of the present invention.

In one example the second indexed region fills the entire blank space 820, and subsequent to self servo writing in the second indexed region 840, the self servo writing operation is complete. In another example, the process of writing spirals in a portion of a radial distance from the interface into the blank region 820 is an incremental process. An incremental process takes more time, but yields a more accurate final servo pattern. In one example, each increment fills approximately 10% of the radial distance between the inner diameter 810 and the outer diameter 812.

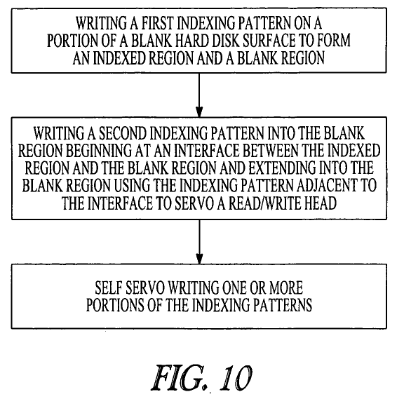

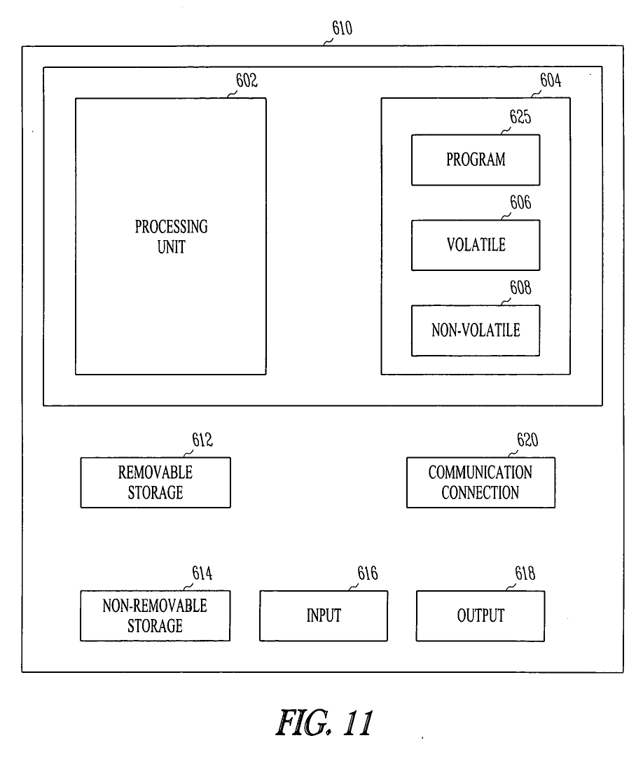

FIG. 10 illustrates an example method as described in some example embodiments described herein. The method lists writing a first indexing pattern on a portion of a blank hard disk surface to form an indexed region and a blank region. As described above one indexing pattern includes one or more spirals. The method also lists writing a second indexing pattern into the blank region beginning at an interface between the indexed region and the blank region and extending into the blank region using the indexing pattern adjacent to the interface to servo a read/write head. The method also lists self servo writing one or more portions of the indexing patterns. Although one example method is shown in FIG. 9, example embodiments are not so limited. One of ordinary skill in the art, having the benefit of the present disclosure will recognize that other variations of methods are also within the scope of the invention.

Using selected methods as described above, spirals or other indexing patterns can be written entirely within a hard disk drive, thus enabling self servo writing of the entire disk surface. Increased accuracy in spiral writing in turn increases the track density achievable using self servo writing techniques. Although examples discussed above discuss performing all operations within a hard disk drive, example embodiments are not so limited.

Software to calculate and perform the drive operations as described above is typically stored in firmware within the hard drive although example embodiments are not so limited. A block diagram of a more general computer system that executes selected methods as described is shown in FIG. 11. A general computing device in the form of a computer 610, may include a processing unit 602, memory 604, removable storage 612, and non-removable storage 614. Memory 604 may include volatile memory 606 and non-volatile memory 608. Computer 610 may include—or have access to a computing environment that includes—a variety of computer-readable media, such as volatile memory 606 and non-volatile memory 608, removable storage 612 and non-removable storage 614. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 610 may include or have access to a computing environment that includes input 616, output 618, and a communication connection 620. The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks. The controller 210 or other selected circuitry or components of the disk drive may be such a computer system.

Computer-readable instructions stored on a computer-readable medium are executable by the processing unit 602 of the computer 610. A hard drive, CD-ROM, and RAM are some examples of articles including a computer-readable medium. The computer program may also be termed firmware associated with the disk drive. In some example embodiments, a copy of the computer program 625 is stored on the disk 11 of the disk drive.

The foregoing description of the specific example embodiments reveals the general nature of the invention sufficiently that others can, by applying current knowledge, readily modify and/or adapt it for various applications without departing from the generic concept, and therefore such adaptations and modifications are intended to be comprehended within the meaning and range of equivalents of the disclosed example embodiments.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

It is to be understood that the phraseology or terminology employed herein is for the purpose of description and not of limitation. Accordingly, the invention is intended to embrace all such alternatives, modifications, equivalents and variations as fall within the spirit and broad scope of the appended claims.

What is claimed is:

1. A method comprising:
writing a first indexing pattern on a portion of a blank hard disk surface to form an indexed region and a blank region;
writing a second indexing pattern into the blank region beginning at or near an interface between the indexed region and the blank region and extending into the blank region; and
wherein writing the second indexing pattern includes using the indexing pattern adjacent to the interface to servo a read/write head.

2. The method of claim 1, wherein writing the first indexing pattern on the portion of the blank hard disk drive surface includes writing from an inner diameter outwards towards an outer diameter.

3. The method of claim 2, wherein writing from the inner diameter outwards towards the outer diameter includes writing in a region between the inner diameter and 10% of the distance to the outer diameter.

4. The method of claim 1, wherein writing the second indexing pattern further includes using back EMF from a voice coil motor to provide a write-clock for writing an index pattern.

5. The method of claim 4, wherein writing the second indexing pattern further includes using back EMF from a spindle motor to provide the write-clock for writing the index pattern.

6. A method comprising:
writing a first number of spirals on a portion of a blank hard disk surface to form a first spiraled region and a blank region;
writing a second number of spirals into the blank region beginning at or near an interface between the first spiraled region and the blank region and extending into the blank region;
wherein writing the second number of spirals includes using the first number of spirals adjacent to the interface to servo a read/write head.

7. The method of claim 6, further including calibrating a mismatch between the first number of spirals and the second number of spirals.

8. The method of claim 6, wherein writing the first number of spirals and writing the second number of spirals are both executed completely within a hard disk drive.

9. The method of claim 6, wherein writing the second number of spirals further includes using back EMF from a voice coil motor to servo a read/write head and back EMF from a spindle motor provide a write-clock for writing an index pattern.

10. The method of claim 6, wherein using the first number of spirals adjacent to the interface to servo a read/write head includes:
first using the first number of spirals to self servo write a servo pattern over the first spiraled region; and
subsequently using the servo pattern to servo the read/write head.

11. A hard disk drive comprising:
a hard disk;
a spindle motor to rotate the hard disk;
a read/write head to follow a track on the hard disk;
computer readable instructions stored in a media and coupled to the hard disk drive such that when executed, the instructions cause the read/write head to perform a number of operations, including:
writing a first number of spirals on a portion of a blank hard disk surface to form a first spiraled region and a blank region;
self servo-writing the first spiraled region to form a first self servo region;
writing a second number of spirals into the blank region beginning at or near an interface between the first spiraled region and the blank region and extending into the blank region to replace at least a portion of the blank region with a second spiraled region;
wherein writing the second number of spirals includes using the first self servo region adjacent to the interface to servo a read/write head; and
self servo writing the second spiraled region.

12. The hard disk drive of claim 11, wherein writing the second number of spirals into the blank region includes incrementally:
writing from a location within the first self servo region adjacent to the interface to a selected distance into the blank region to form an incremental spiraled region:
self servo-writing the incremental spiraled region; and
repeating increments until the blank region is replaced.

13. The hard disk drive of claim 12, wherein the selected distance includes approximately 10% of the distance between an inner diameter and an outer diameter of the hard disk surface for each increment.

14. The hard disk drive of claim 13, wherein the first number of spirals are written in a direction from an inner diameter towards an outer diameter of the hard disk surface.

15. The hard disk drive of claim 14, further including calibrating a mismatch between the first number of spirals and the second number of spirals.

16. The hard disk drive of claim 11, wherein writing the second number of spirals further includes using back EMF from a voice coil motor to servo the read/write head.

17. The hard disk drive of claim 11, wherein writing the second number of spirals further includes using back EMF from a voice coil motor and back EMF from a spindle motor to provide a write-clock for writing an index pattern.

18. The hard disk drive of claim 11, wherein the computer readable instructions are stored in firmware within the hard disk drive.
